(19) United States
(12) Patent Application Publication
(10) Pub. No.: US 2008/0193358 A1
(43) Pub. Date: Aug. 14, 2008

(54) Method for the Production of a Catalytically Active Mineral on the Basis of a Tectosilicate

(75) Inventors: Spyridon Tzintzos, Athen (GR); Kisnaduth Kesore, Marl (DE)

Correspondence Address: COLLARD & ROE, P.C., 1077 NORTHERN BOULEVARD, ROSLYN, NY, 11576, US

(73) Assignee: S & B INDUSTRIAL MINERALS GMBH, Marl (DE)

(21) Appl. No.: 11/885,692

(22) PCT Filed: Mar. 3, 2006
(86) PCT No.: PCT/EP2006/001957

§ 371 Date: Jan. 8, 2008

(30) Foreign Application Priority Data
Mar. 5, 2005 (DE) 10 2005 010 221.2

(51) Int. Cl. C01B 33/20

(52) U.S. Cl. 423/326

(57) ABSTRACT

The invention relates to a method or producing a catalytically active tectosilicate-based mineral consisting in treating the tectosilicate with a metal salt solution and in drying it. The invention is characterized in that the dried tectosilicate is treated in the form of hydrogen with a copper-based metal salt during a solid state ion exchange.

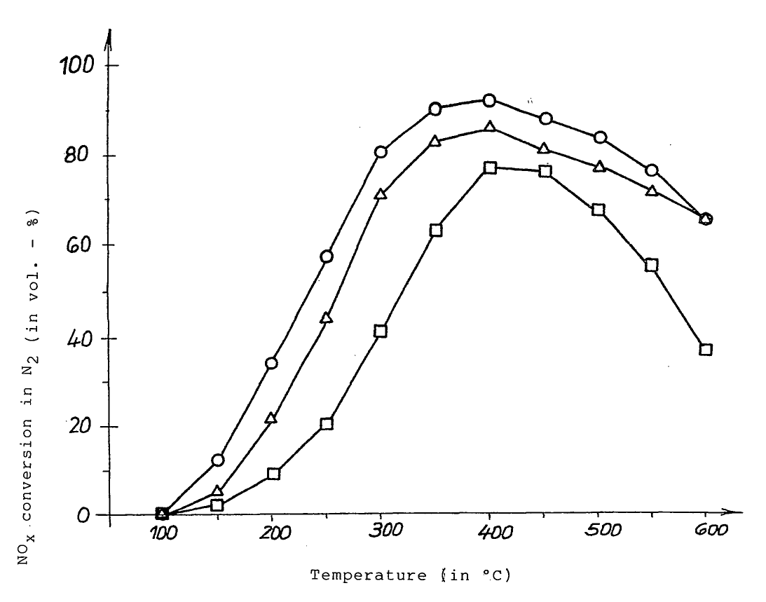

The invention relates to a method for the production of a catalytically active mineral on the basis of a tectosilicate, according to which the tectosilicate is first treated with a metal salt solution and subsequently dried.

The method of procedure indicated above is known, and reference is made to DE 40 16 688 C3 or also DE 30 00 383 A1, in this regard, merely as examples. It is known that such catalytically active minerals usually serve for the purpose of removing Noₓ from exhaust gases. In fact, the aforementioned nitrogen oxides are reduced using a catalytic converter produced from the catalytically active mineral, and converted to harmless nitrogen N₂, for the most part. In this connection, the so-called conversion rate in volume percent represents a quality criterion for the catalytically active mineral, i.e. for the catalytic converter as a whole. The greater the volume percent of NOₓ converted to nitrogen, the better suited the mineral in question as a catalytic converter material, i.e. as a basic catalytic converter material, for example in the automotive industry.

In practice, however, there are several problems. For example, until now, precious metals such as platinum, rhodium, or palladium have been used in catalytic converters used in motor vehicles, for example, for the formation of the active catalytic converter layer. In the meantime, however, there are concerns about the use of these precious metals, from environmental and medical aspects. This is because in the case of such catalytic converters, the active catalytic converter layer, for example one made of platinum, is released over the course of time, and is given off into the ambient air. As a consequence, platinum accumulations in the environment can be found, particularly in the region of high-traffic roads, and also in the human body; there is as yet no clarity about their possible negative effects. As a consequence of this, there is a growing need to make almost emission-free catalytic converters available.

In the case of the previously indicated alternative catalytic converter concepts, for example on the basis of zeolites (cf. DE 40 16 688 C3 or DE 30 00 383 A1) it turned out that by-products harmful to health, for example in the form of HCNO, were also emitted. Furthermore, the catalytic converters described do not have the required temperature stability and resistance to water, sulfur oxides, and, if applicable, heavy metals. This means that the durability of the known zeolite catalytic converters in accordance with DE 40 16 688 C3 and DE 30 00 383 A1 is just as much in need of improvement as their emission behavior.

Finally, in the case of the known methods of procedure for the production of a catalytically active mineral on the basis of zeolite, in particular, it is noteworthy that in all cases, an acid treatment is carried out. For example, DE 30 00 383 A1 speaks about the fact that natural clinoptilolith is first treated with an ammonium nitrate solution and subsequently with hydrochloric acid. DE 40 16 688 C3 proceeds in similar manner. This not only makes production problematic, but also waste water that is difficult to control occurs.

A method for the modification of molecular sieves or zeolites by means of ion exchange is described in DE 43 04 821 A1. In this connection, cations of a metal from the first to eighth subgroups of the periodic system are used, in the form of a salt or an oxide. For pre-treatment, the zeolite used is subjected to multiple ion exchange in aqueous suspension, with a great excess of NH₄NO₃ solution. Subsequently, calcination takes place at approximately 550° C. (cf. Example 1).

Furthermore, a method for the catalytic reduction of nitrogen oxides in exhaust gases has become known from US 2003/0165415 A1. For this purpose, a catalytic converter, i.e. a basic catalytic converter material, of the aluminum silicate type is described, which is treated with a transition metal in aqueous solution.

The possibility of installing transition metal ions into zeolites is described within the scope of the prior publication “Introduction of cations into zeolites by solid-state reaction.”

Finally, DE 196 37 032 A1 concerns itself with a method for removing nitrogen oxides from lean exhaust gases. For this purpose, a catalytic converter is produced, in which a zeolite is brought into contact with a metal salt that is in the solid state, and subsequently the metal salt is reduced to the corresponding metal. The introduction of the metal into the zeolite takes place by way of a solid-body reaction, in which the zeolite is intimately mixed with the metal salt or a metal salt mixture, for example in a ball mill. Details regarding the prior treatment of the zeolites remain open.

The invention is based on the technical problem of further developing a method for the production of a catalytically active mineral on the basis of a tectosilicate, having the structure described initially, in such a manner that a basic catalytic converter material is made available that is as free of emissions as possible, has an increased useful lifetime, and can be produced as simply, cost-advantageously, and with as few problems, in terms of process technology, as possible.

To solve this technical problem, the object of the invention is a method of the type stated, for the production of a catalytically active mineral on the basis of a tectosilicate, for use as a basic catalytic converter material, in the catalytic purification of exhaust gases, particularly in automobiles, according to which the tectosilicate is first treated with a metal salt solution, and subsequently dried, and according to which the dried tectosilicate is treated in the hydrogen form, with a metal salt, particularly on the basis of a transition metal, within the course of a solid body ion exchange.

The metal salt on a transition metal basis is preferably one on a copper basis and/or iron basis. Alkali alumosilicates and earth alkali alumosilicates are regularly used as a tectosilicate or tectosilicate; their framework structure is very loose and wide-meshed, causing channel-like cavities to occur. As a consequence of these cavities, there is the possibility of being able to install additional ions or molecules into the lattice without any significant change in the structure.

Particularly preferably, the invention uses a natural mineral as the tectosilicate, and here, in particular, natural minerals of the zeolite type, preferably those of the heulandite type, very particularly preferably clinoptiloliths. It is known that the zeolites preferably used are also referred to as “molecular sieves.” In the case of natural zeolites, approximately 45 structures are known, which contain different amounts of earth alkalis and alkalis, such as calcium ions, magnesium ions, or potassium ions, depending on the mining location from which they were obtained, and depending on the zeolite type in question. These cations change the entry pores to the inner cavities of the silicon/aluminum crystal lattice of the tectosilicate in question, which were described. In this connection, it has fundamentally turned out that natural minerals, and particularly natural zeolite, are more thermally stable than synthetic zeolite, for example.

In fact, natural zeolites have a special texture with mesopores and macropores, which are not observed in the case of synthetic zeolites. The texture indicated above, in particular, makes the absorption of organic compounds possible, whose radii are larger than the entry channels of the micropores that are also present in the case of synthetic zeolites. Furthermore, this texture is presumably responsible for the greater thermal stability of natural zeolite as compared with synthetic zeolite. In fact, it has turned out that the catalytically active mineral produced according to the method according to the invention, particularly on the basis of a natural zeolite, is thermally stable up to temperatures of 500° C. and even more, and makes conversion rates of NOₓ to nitrogen available that are clearly above 50 vol.-%, even in this range. This means that more than 50 vol.-% of NOₓ are converted to nitrogen.

In this connection, it has further proven itself if the natural zeolite used contains more than 50 wt.-%, preferably more than 70 wt.-%, particularly more than 80 wt.-%, and particularly preferably more than 90 wt.-% clinoptilolith. Clinoptilolith is an aluminum silicate that reacts anionically, and is responsible as an ion exchanger with regard to cations and also as an absorber for fluids, as well as an absorber/adsorber for gases, because of its lattice structure and the great internal and external surface and porosity, and has particular catalytic effects.

Since the tectosilicate used according to the invention is predominantly a natural mineral, particularly natural zeolite, of course not only clinoptilolith but also fundamentally, chabasite, mordenite, etc., or mixtures of them, can also be used. In fact, it has proven itself if the tectosilicate used contains at least 45 wt.-% natural zeolite, particularly more than 75 wt.-%, and particularly preferably more than 80 wt.-%. The remainder of the tectosilicate used can be formed, for example, of synthetic zeolites, which, however, always have a lower weight proportion than the natural zeolites. This means that in the case of the tectosilicate according to the invention, natural zeolite dominates in terms of weight and as a matter of preference, so that the advantages described above (different pore diameters and great thermal stability) are obtained in every case.

The natural zeolite used is mainly the heulandite already mentioned, and here, in particular, clinoptilolith, which represents the main component of the natural zeolite, in each instance.

In the case of the metal salt solution, an ammonium chloride/ammonium nitrate solution or the like, particularly on an ammonium basis, is predominantly used. As a result, the natural zeolite that is predominantly used not only experiences purification, but also it is transformed into the desired hydrogen form. In this process, ammonium ions NH₄ replace individual cations in the tectosilicate or the natural zeolite, for example calcium ions or sodium ions. In this connection, the treatment with the metal salt solution or ammonium chloride takes place predominantly at room temperature or at elevated temperatures up to approximately 60° C. In this connection, the mixture ratio provides that usually, more than 50 g, preferably more than 100 g, and particularly preferably up to approximately 300 g of tectosilicate or natural zeolite are used per liter of metal salt solution, whereby water is usually used as the solvent.

Because of the replacement of individual cations by means of ammonium ions and subsequent drying at temperatures of more than 80° C. and preferably at approximately 100° C., the ammonia evaporates and the dried tectosilicate is present in the desired hydrogen form, in that cations in the tectosilicate or zeolite have been exchanged for hydrogen ions. Because of this process alone, the removal of NOₓ from the waste gas is already promoted. This is particularly true for the case that a reduction agent is added to the waste gas. This is achieved, in practice, in that nowadays, in the case of diesel engines, for example, aqueous urea solutions or solid urea in palletized and pulverized form are used as reduction agents. The direct use of fuel as a reduction agent is also possible, for example in that, in the case of diesel engines, the diesel fuel is directly injected into a catalytic converter equipped in this manner. Such a procedure is generally not necessary in the case of internal combustion engines that run on gasoline, because here, the waste gas itself contains an amount of hydrocarbons sufficient for the NOₓ reduction.

According to the invention, the drying process of the tectosilicate in the hydrogen form, treated with the metal salt solution, is followed by treatment with a metal salt on the basis of a transition metal, i.e. copper basis and/or iron basis, within the course of a solid body ion exchange. In this way, it is explicitly possible to do without an acid treatment, which has the negative consequences outlined above, in contrast to the state of the art. Instead, another ion exchange of the cations occurs in the cavities of the tectosilicate (in addition to the partial exchange with ammonium and hydrogen ions, respectively, that has already taken place), specifically by means of predominantly copper atoms and/or iron atoms in the dry phase. Such a solid body ion exchange is fundamentally known, and reference is made, in this regard, to the essay by M. Crocker et al., “Preparation of acidic forms of montmorillonite clay via solid-state ion-exchange reactions” (CATALYSIS LETTERS, Vol. 15, 1992, pages 339-345). Supplementally, reference is made to WO 2004/030817 A2.

A different positioning of the cations in the cavities and at the openings of the cavities is achieved by means of the combination of purification and/or impregnation, first of all with the metal salt solution, and the concomitant first ion exchange of the cations in the cavities of the tectosilicate, and the subsequent dry treatment with the metal salt, in connection with the second ion exchange. In fact, one will expect that the ammonium or hydrogen ions predominantly dispose themselves in large-volume cavities or at their openings, because of the concomitant impregnation or treatment in the metal salt solution. This is attributable to the hydratization of the ions in question, in the solution, which prevents their penetration into narrow cavities or their interior. In contrast, the copper atoms and/or iron atoms embedded in the case of the second ion exchange are able, in the case used as an example, to penetrate into the interior of the said cavities because of the solid-body reaction connected with it (because they are not surrounded by a large-volume hydrate sheath).

In any case, the dried tectosilicate in the hydrogen form is mixed with copper nitrate, for example, in dry form, and ground, if necessary, and subsequently subjected to a drying process. In this connection, the work is generally carried out with a shock-like temperature increase, starting at approximately 100° C. up to approximately 500° C. (or even higher). For example, the 100° C. are reached in approximately 10 minutes. This means that the temperature gradient is approximately 10° C./min or more in the case of the shock-like temperature increase described. As a result, the copper atoms, i.e. transition metal ions in general, of titanium, iron, cobalt, nickel, or zinc, for example, are able to replace the cations present in the tectosilicate, such as calcium ions, sodium ions, or potassium ions, at least in part. Subsequent to the sudden heating described, the tectosilicate treated in this manner can also be calcinated, whereby the drying process and the calcination, in other words the removal of any water of crystallization or of solvents, can also be combined, of course. At the same time, carbon dioxide is split off as a result of this process. In addition, the potassium ions that are present unchanged assure thermal stabilization.

In any case, the copper cations or iron cations that are predominantly embedded in the intermediate layer, in each instance, or, for the most part, in the interior of the cavities, are able to split the nitrogen oxides NOₓ, which are a particular problem, at elevated temperature, essentially into nitrogen (N₂) and oxygen (O₂). Not only is the desired catalytic effect achieved by means of the use of mainly copper or iron, or a transition metal, in general, which is usually present at more than 0.1 wt.-% in the treated tectosilicate, particularly in a concentration of more than 1.0 wt.-%, and particularly preferably in a range of 1.5 to 2.5 wt.-%, in any case, at less than 5 wt.-%, as a rule, but also, this effect is based on a non-toxic metal that is not volatile at the temperatures reached. In fact, temperatures of at most 500° C. are generally achieved in a catalytic converter in the case of motor vehicles. At this temperature, the known precious metals such as platinum already evaporate, whereas the copper (iron) that is advantageously used according to the invention is still far from reaching its melting temperature, and consequently, a transition into the gas phase is not observed. Furthermore, copper (iron) is an inexpensive metal that also makes the disposal of a catalytic converter or catalytic mineral prepared in this manner simple.

Alternatively to the method of procedure described, for example that of mixing copper nitrate (iron nitrate), dry, with the tectosilicate in hydrogen form, grinding it, if necessary, and heating it, it is also possible to use a metal solution, for example copper nitrate solution or the like. In this connection, the concentration of the solution must be adjusted in such a manner, in comparison with the tectosilicate treated in this manner and previously dried, that the treated, dried tectosilicate has moisture values comparable to those in the natural state after the treatment. This means that the prior drying process after the reaction with the metal salt solution is conducted, in this case, in such a manner that moisture content is clearly below the natural moisture content of the tectosilicate, of 10 wt.-% to 20 wt.-%, for example, and approximately reaches the latter again as a result of the subsequent treatment with the copper solution (iron solution). The calcination that follows in both cases then assures that any remaining solvents are removed. This means that the copper solution is used in such a manner that the dried tectosilicate in the hydrogen form remains dry except for a water content that lies within the range of the natural moisture.

Fundamentally, the metal salt on the basis of a transition metal usually contains more than 50 wt.-% copper and/or iron. This holds true analagously fo the metal solution, i.e. copper solution or iron solution. In addition, of course, other metals, particularly transition metals and/or alkali metals, can be used as supplemental mixture components. This means that it is possible to mix the tectosilicate, dry, with a mixture of copper nitrate and zinc nitrate, for example, and to suddenly heat it as described. The copper nitrate solution in combination with a zinc chloride solution can be used as an alternative, just as well, in the case given as an example.

The catalytically active mineral or natural zeolite produced in this manner can be brought into any desired form. In this connection, a self-binding effect can be achieved by means of the simple addition of water to the powder produced. This means that the mineral produced in this manner can be extruded in any desired shapes, for example, or also applied to a basic catalytic converter material as a coating. No special binder is required, so that possible negative influences of such a binder on the selectivity of the catalytic effect are not observed.

Finally, it is of particular importance how large the grain size of the catalytically active mineral is adjusted to be before and during the treatment described, respectively. Usually, the tectosilicate is ground before the treatment, whereby it has proven itself if 90% of the particles produced in this manner have a grain size of less than 1 mm, particularly one of less than 250 μm, and preferably below 25 μm, and particularly preferably of less than 5 μm. In fact, it has turned out that the grinding fineness has an influence on the conversion rate already described above that is not without significance. This conversion rate indicates how many weight percent of NOₓ in the waste gas are converted to nitrogen. The effect of the grinding fineness as a function of various temperatures of the catalytic converter material or the catalytically active mineral can be recognized using the attached single figure.

There, the conversion rate already described is plotted on the Y axis, in volume percent, as compared with the temperature in ° C. on the X axis. In total, three curves are shown, of which the one with the circles reflects the greatest conversion rate over the entire temperature range. In fact, a natural zeolite having a predominant proportion (more than 50 wt.-%) of heulandite or clinoptilolith was ground over a period of approximately 7 hours here, until approximately 90% of the particles had a grain size of less than 5 μm. After firing of the aforementioned material at approximately 500° C., the conversion rate drops by less than 10% over the entire progression. This is shown by the second curve, marked with triangles.

On the basis of a comparison of the two temperature progressions, one can see that even temperatures of approximately 500° C., which tend to be unusual in the case of a catalytic converter in the motor vehicle sector, the conversion rate of the natural mineral or zeolite treated according to the method according to the invention does not drop significantly. This speaks in favor of the particular durability and increased useful lifetime of the basic catalytic converter material produced in this manner. In comparison with a natural zeolite without special grinding treatment (squares), the conversion efficiency is clearly improved. In fact, in the case of this zeolite, 90% of the particles are in the range below 250 μm, and are represented by the curve marked with squares. In any case, it becomes clear what the NOx conversion rate can be significantly increased by means of increasing the grinding fineness, whereby furthermore—and this is of particular significance—the conversion rate does not drop below 70 vol.-% over the entire temperature range that is of interest, in the case of the versions with 90% of the particles below 5 μm.

In the end result, a catalytically active material can be made available as a basic catalytic converter material for catalytic waste gas purification, particularly in automobiles, by means of a simple physical-chemistry process, which process not only successfully converts NOx into nitrogen, but furthermore is active in a clearly broadened temperature range, as compared with the state of the art, which ranges from approximately 150° C. all the way to approximately 700° C. This is possible while doing without so-called PGM metals, in other words those of the platinum group. In total, the restrictions connected with this are overcome, whereby in addition, a clearly increased resistance to water and a particular selectivity with regard to the conversion of NOₓ to nitrogen is observed. Another advantage of a catalytic converter produced in this manner can be seen in the fact that the DeNOₓ reaction works both with ammonium ions and hydrocarbon ions. As a result of the great selectivity, no cyanates or comparable toxic gases are produced. Furthermore, there is no risk of ammonia slippage, in other words the break-through of free NH₃ through the catalytic converter, which must absolutely be avoided because of the toxicity of ammonia.

A catalytic converter that is used on the basis of the catalytically active mineral as the basic catalytic converter material, specifically in motor vehicles and here, for waste gas purification, is also an object of the invention. In this connection, the catalytically active mineral described can also be combined with a catalytically active phyllosilicate, the intermediate layer of which has supportive metal atom pillars, and possesses metal atoms embedded in the intermediate layer, particularly so-called pillared clays.

This means that the present innovation also covers combinations of a two-part catalytically active molded body, for example, in the case of which the one molded body, as the catalytic converter, makes use of the tectosilicate or zeolite described, while the other molded body is configured as a so-called pillared clay in accordance with WO 2004/030817 A2. In this way, a particularly advantageous catalytic effect is achieved, particularly in the sense of marked selectivity for the conversion to nitrogen. In fact, the pillared clay molded body is particularly active in the low-temperature range, while the catalytic converter on the basis of zeolite mainly covers the higher temperature range.

In total, the following particular advantages of the basic catalytic converter material produced according to the method described can be claimed: predominantly, no synthetic materials are used, but rather mainly inexpensive natural minerals and here, in particular, natural zeolite. In this connection, the purification process with the metal salt solution takes place predominantly at room temperature or only slightly elevated temperatures, in other words it is particularly energy-efficient. The flexible ion exchange described takes place essentially in two stages, as described, specifically as a result of solid body ion exchange, without harmful waste waters.

Because expensive metals are eliminated for the catalytic effect, and in contrast, inexpensive transition metals are used, the production of the basic catalytic converter material is possible in particularly inexpensive manner. Nevertheless, there is great selectivity of the catalytic effect. Furthermore, a broad temperature range is covered, so that the basic catalytic converter material is suitable both for low-temperature and high-temperature applications. These are the significant advantages.

1. Method for the production of a catalytically active mineral on the basis of a tectosilicate, for use as a basic catalytic converter material, in the catalytic purification of exhaust gases, particularly in automobiles, according to which the tectosilicate is first treated with a solution on the basis of ammonia, and converted to the hydrogen form, according to which subsequently the tectosilicate is dried and treated with a metal salt, within the course of a solid body ion exchange, and according to which finally the tectosilicate treated with the metal salt is heated in shock-like manner at a temperature of more than 80° C., with a temperature gradient of 10° C./min or more.

2. Method according to claim 1, wherein the tectosilicate is predominantly a natural mineral, for example natural zeolite.

3. Method according to claim 1, wherein an ammonium chloride solution, ammonium nitrate solution, or similar solution is used as the solution on the basis of ammonia.

4. Method according to claim 1, wherein the tectosilicate is ground before treatment, whereby 90% of the particles have a grain size of less than 1 mm, particularly one of less than 250 μm, preferably below 25 μm, and particularly preferably of less than 5 μm.

5. Method according to claim 1, wherein a metal salt on the basis of a transition metal is used as the metal salt.

6. Method according to claim 1, wherein copper nitrate is mixed with the dried tectosilicate in the hydrogen form, as the metal salt on the basis of copper, and ground, if necessary.

7. Method according to claim 1, wherein the treated tectosilicate is calcinated in a final step, specifically at a temperature of more than 300° C., preferably more than 400° C., particularly preferably at a temperature of more than 450° C.

8. Method according to claim 1, wherein the metal salt solution is used in a concentration of more than 50 g, preferably more than 100 g to approximately 300 g tectosilicate per liter of metal salt solution.

9. Method according to claim 1, wherein the tectosilicate treated with the metal salt is dried in shock-like manner at a temperature of more than 80° C., preferably more than 100° C.

10. Method according to claim 1, wherein the treated tectosilicate is brought into a desired form, for example pellets, an extrudate, etc., if necessary with the addition of fluid.
